(19) United States
(12) Patent Application Publication
(10) Pub. No.: US 2013/0199288 A1
(43) Pub. Date: Aug. 8, 2013

(54) FLUID FLOW DISTRIBUTION DEVICE

(71) Applicant: Lakhi Nandlal Goenka, Ann Arbor, MI (US)

(72) Inventor: Lakhi Nandlal Goenka, Ann Arbor, MI (US)

(73) Assignee: VISTEON GLOBAL TECHNOLOGIES, INC., Van Buren Twp., MI (US)

(21) Appl. No.: 13/364,450

(22) Filed: Feb. 2, 2012

(51) Int. Cl. G01F 5/00

(52) U.S. Cl. 73/202

(57) ABSTRACT

A fluid flow distribution device for a fluid component configured to improve a distribution of a fluid flow therein. The fluid flow distribution includes a plurality of walls. The walls form a chamber configured to receive a fluid flow from a fluid source therein. The chamber is in fluid communication with a fluid inlet of the fluid component and a plurality of flow paths. Each of the flow paths includes an inlet and an outlet. At least one of the walls includes an inner surface, wherein a distance between the inner surface and a plane generally defined by the inlets of the flow paths non-uniformly progressively decreases in respect of a general direction of the fluid flow into the fluid flow distribution device to downwardly direct the fluid flow into the flow paths adjacent thereto.

### FIELD OF THE INVENTION

The present invention relates to a fluid flow device, and more particularly to a fluid flow device configured to improve a distribution of a fluid flowing therein.

### BACKGROUND OF THE INVENTION

There are many fluid components that require a desired distribution of a fluid flow among multiple flow paths from a common fluid flow source. Generally, the desired distribution is that of a uniform fluid flow among the flow paths. One example of such fluid flow components is a heat exchanger, and particularly a heat exchanger that operates as an evaporator or a vaporizer. Because heat absorbed by a fluid that is being evaporated or vaporized is mostly latent heat, a majority of each of the flow paths of such a heat exchanger is typically occupied by a two-phase fluid. Unlike some heat exchangers such as condensers, for example, the distribution of the fluid flow in the evaporator and vaporizer is not self-correcting. Accordingly, different flow conditions can coexist in parallel flow paths and can produce a pressure drop (i.e., high mass flow with low quality change or low mass flow with super heat). The different flow conditions can also cause heat fluxes that vary significantly from flow path to flow path (i.e., from tube to tube), negatively affecting performance and stability in the heat exchanger.

Another example of such fluid flow components is an air flow system, and particularly a zonal air flow system. A conventionally-known air flow system includes an air duct employed in a headliner of a vehicle. The air duct has a plurality of passages for delivering conditioned air to a passenger compartment of the vehicle. Because of limited space in the headliner of the vehicle, the air duct must meet certain size and packaging constraints, making uniform flow distribution among the passages difficult and/or costly to obtain.

It is desirable to develop a device that uniformly distributes a fluid flow from a common source among a plurality of flow paths of a fluid component, wherein a performance and an efficiency of the fluid component are maximized, while a package size and a cost thereof are minimized.

### SUMMARY OF THE INVENTION

In concordance and agreement with the present invention, a device that uniformly distributes a fluid flow from a common source among a plurality of flow paths of a fluid component, wherein a performance and an efficiency of the fluid component are maximized, while a package size and a cost thereof are minimized, has surprisingly been discovered.

In one embodiment, the fluid flow distribution device, comprises: a plurality of walls forming a chamber configured to receive a fluid flow therein, wherein the chamber is in fluid communication with a fluid inlet and a plurality of flow paths, each of the flow paths including an inlet, wherein a distance between an inner surface of at least one of the walls and a plane generally defined by the inlets of the flow paths non-uniformly progressively decreases in respect of a general direction of the fluid flow into the fluid flow distribution device.

In another embodiment, the fluid flow distribution device, comprises: a plurality of walls forming a chamber configured to receive a fluid flow therein, the chamber in fluid communication with a fluid inlet and a plurality of flow paths, wherein at least one of the walls includes an inner surface having a first section adjacent the fluid inlet and a second section adjacent the first section, and wherein a rate of change in volume of a first portion of the chamber adjacent the first section of the inner surface is greater than a rate of change in volume of a second portion of the chamber adjacent the second section of the inner surface.

In another embodiment, the fluid flow distribution device, comprises: a plurality of walls forming a chamber configured to receive a fluid flow therein, wherein the chamber is in fluid communication with a fluid inlet and a plurality of flow paths, each of the flow paths including an inlet, wherein a rate of change in distance between an inner surface of at least one of the walls and a plane generally defined by the inlets of the flow paths decreases as a distance from the fluid inlet increases.

### DESCRIPTION OF THE DRAWINGS

The above, as well as other advantages of the present invention, will become readily apparent to those skilled in the art from the following detailed description, when considered in the light of the accompanying drawings:

FIG. 1 is a fragmentary schematic cross-sectional elevational view of a fluid component including a fluid flow distribution device according to an embodiment of the invention, showing a first portion of an upper wall of the fluid flow distribution device having a substantially constant slope and a second portion of the upper wall having a substantially constant slope, wherein the substantially constant slope of the first portion is greater than the substantially constant slope of the second portion;

FIG. 2 is a fragmentary schematic cross-sectional elevational view of the fluid component illustrated in FIG. 1, showing the first portion of the upper wall having a variable slope and the second portion of the upper wall having a substantially constant slope, wherein the variable slope of the first portion is greater than the substantially constant slope of the second portion;

FIG. 3 is a fragmentary schematic cross-sectional elevational view of the fluid component illustrated in FIGS. 1-2, showing the first portion of the upper wall having a substantially constant slope and the second portion of the upper wall having a variable slope, wherein the substantially constant slope of the first portion is greater than the variable slope of the second portion;

FIG. 4 is a fragmentary schematic cross-sectional elevational view of the fluid component illustrated in FIGS. 1-3, showing the first portion of the upper wall having a variable slope and the second portion of the upper wall having a variable slope, wherein the variable slope of the first portion is greater than the variable slope of the second portion;

FIG. 5 is a fragmentary schematic cross-sectional elevational view of a fluid component including a fluid flow distribution device according to another embodiment of the invention, showing a first portion of an upper wall of the fluid flow distribution device having a substantially constant slope and a second portion of the upper wall having a substantially constant slope, wherein the substantially constant slope of the first portion is greater than the substantially constant slope of the second portion;

FIG. 6 is a fragmentary schematic cross-sectional elevational view of the fluid component illustrated in FIG. 5, showing the first portion of the upper wall having a variable slope and the second portion of the upper wall having a substantially constant slope, wherein the variable slope of the first portion is greater than the substantially constant slope of the second portion;

FIG. 7 is a fragmentary schematic cross-sectional elevational view of the fluid component illustrated in FIGS. 5-6, showing the first portion of the upper wall having a substantially constant slope and the second portion of the upper wall having a variable slope, wherein the substantially constant slope of the first portion is greater than the variable slope of the second portion;

FIG. 8 is a fragmentary schematic cross-sectional elevational view of the fluid component illustrated in FIGS. 5-7, showing the first portion of the upper wall having a variable slope and the second portion of the upper wall having a variable slope, wherein the variable slope of the first portion is greater than the variable slope of the second portion;

FIG. 9 is a fragmentary schematic cross-sectional elevational view of the fluid component illustrated in FIG. 5, showing variably spaced flow passages;

FIG. 10 is a fragmentary schematic cross-sectional elevational view of the fluid component illustrated in FIG. 5, showing variably sized flow passages; and

FIG. 11 is a fragmentary top plan view partially in section of the fluid component illustrated in FIGS. 5-10, showing a tapered fluid inlet.

### DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner.

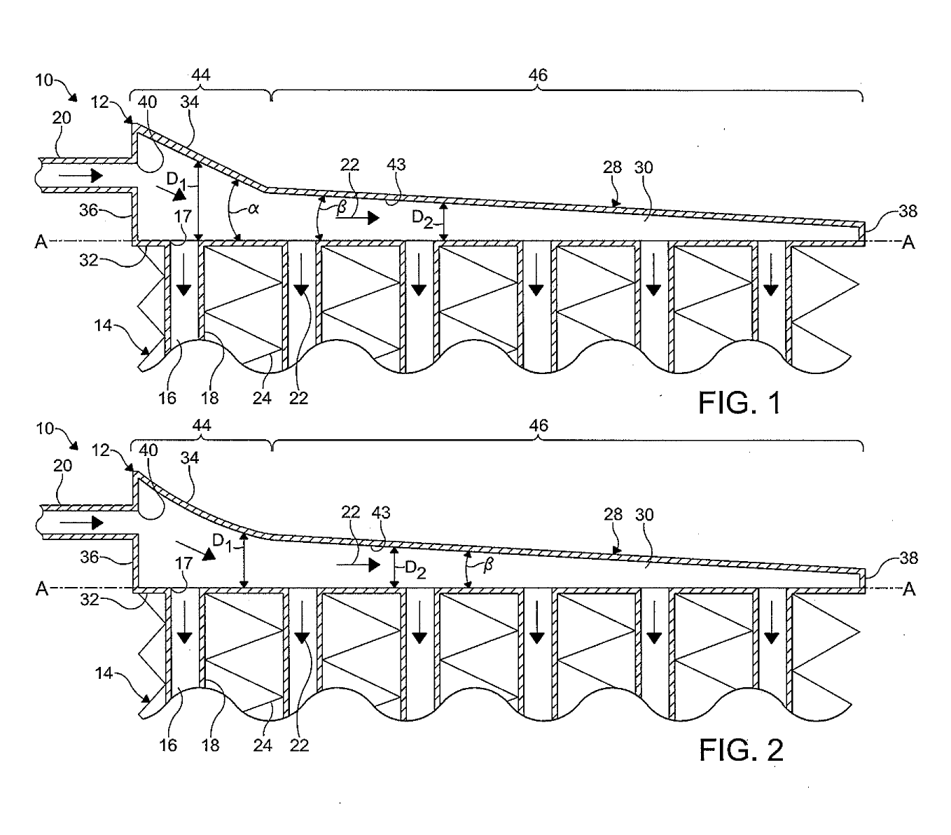

FIGS. 1-4 show a fluid flow component 10 including a fluid flow distribution device 12. The fluid flow distribution device 12 shown is used in connection with a heat exchanger 14. The heat exchanger 14 includes multiple parallel heat exchange flow paths 16. Each of the flow paths 16 includes an inlet 17 and an outlet (not shown). The flow paths 16 shown are define by extruded, flattened tubes 18. It understood that while the fluid flow distribution device 12 shown is employed in connection with the heat exchanger 14 including the flow paths 16, the fluid flow distribution device 12 can be employed in connection with any other suitable form of a heat exchanger or a heat exchange flow path such as a heat exchanger including welded tubes, a stacked-plate type heat exchanger, and a bar-plate type heat exchanger, for example. It is further understood that while the heat exchanger 14 shown includes six flow paths 16, the fluid flow distribution device 12 can be used in any suitable heat exchanger having two or more flow paths that require the fluid flow to be distributed therebetween. Accordingly, no limitation is intended to a particular type or number of flow paths.

The heat exchanger 12 further includes a fluid inlet 20 provided on an inlet end of the heat exchanger 12. The fluid inlet 20 receives a fluid flow, indicated by arrows 22, from a fluid source (not shown). The fluid flow is distributed among the heat exchange flow paths 16 and the tubes 18. The distributed fluid flow passes through the tubes 18 for a transfer of heat to another fluid flow (e.g. air) that is in heat exchange relation with the tubes 18. In certain embodiments, a plurality of fins 24 is disposed between adjacent tubes 18 to further facilitate the transfer of heat between the fluid flows. A collection manifold (not shown) may be provided on an outlet end of the heat exchanger 14 to collect the distributed fluid flow from the tubes 18.

As shown in FIGS. 1-4, the fluid flow distribution device 12 is a fluid manifold provided on the inlet end of the heat exchanger 12 to receive the fluid flow therein. The fluid flow distribution device 12 includes an outer peripheral wall 28 forming a chamber 30 for receiving the fluid flow therein. In certain embodiments, the outer wall 28 of the fluid flow distribution device 12 is formed by a lower wall 32, an opposing upper wall 34, a front wall (not shown), a rear wall (not shown), a first side wall 36, and a second side wall 38. An inlet orifice 40 in fluid communication with the fluid inlet 20 of the heat exchanger 12 is formed in the first side wall 36.

The upper wall 34 of the fluid flow distribution device 12 has an inner surface 43. In certain embodiments, the inner surface 43 of the upper wall 34 includes a first section 44 and a second section 46. As shown, the first section 44 is adjacent the fluid inlet 20 and extends between the first side wall 36 and the second section 46. The second section 46 is adjacent the first section 44 and extends between the first section 44 and the second side wall 38. In a non-limiting example illustrated in FIG. 1, the first section 44 of the inner surface 43 has a substantially constant slope at an angle α in respect of a plane A generally defined by the inlets 17 of the flow paths 16. Further, the second section 46 of the inner surface 43 has a substantially constant slope at an angle β in respect of the plane A. As shown, the angle of slope a of the first section 44 is greater than the angle of slope β of the second section 46. It is understood that the substantially constant slope of the first section 44 and the substantially constant slope of the second section 46 can be at any suitable angles as desired.

In another non-limiting example illustrated in FIG. 2, the first section 44 of the inner surface 43 has a variable slope in respect of the plane A. The second section 46 of the inner surface 43 has a substantially constant slope at the angle β in respect of the plane A. As shown, the variable slope of the first section 44 is greater than the angle of slope β of the second section 46. It is understood that the slope of the first section 44 can vary as desired and the substantially constant slope of the second section 46 can be at any suitable angle as desired. Although the first section 44 shown has a substantially concave shape in respect of the plane A, it is understood that the first section 44 can have any suitable shape as desired such as a substantially convex shape in respect of the plane A, for example.

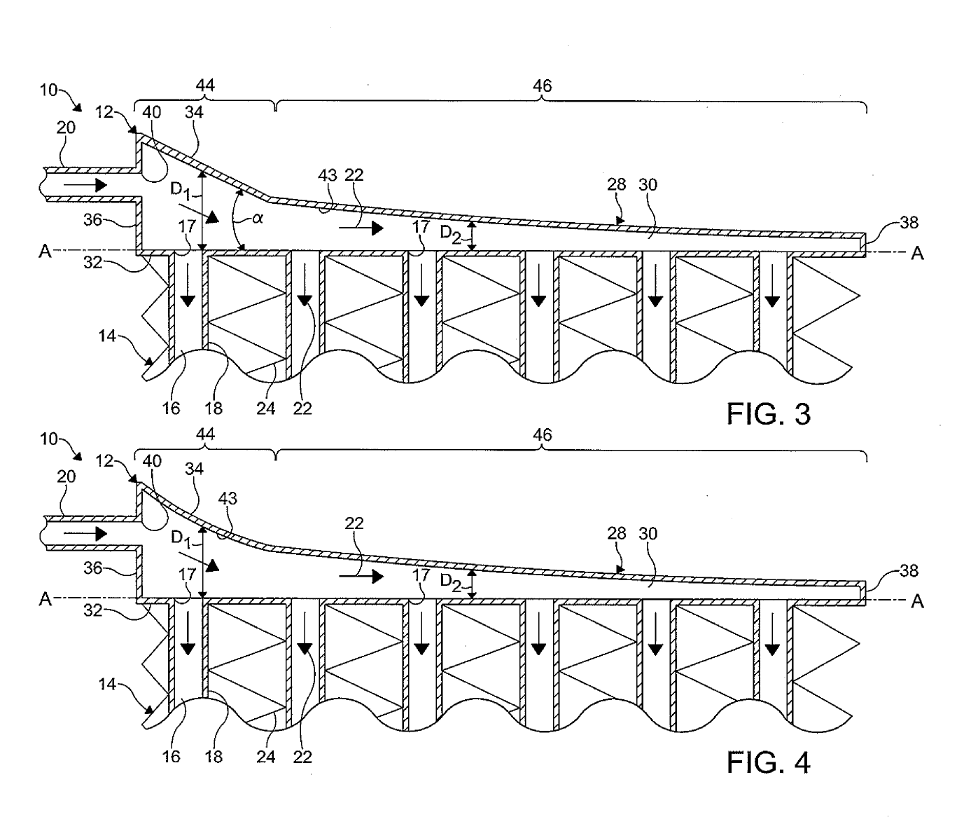

In yet another non-limiting example illustrated in FIG. 3, the first section 44 of the inner surface 43 has a substantially constant slope at an angle α in respect of the plane A. The second section 46 of the inner surface 43 has a variable slope in respect of the plane A. As shown, the angle of slope α of the first section 44 is greater than the variable slope of the second section 46. It is understood that the substantially constant slope of the first section 44 can be at any suitable angle as desired and the slope of the second section 46 can vary as desired. Although the second section 46 shown has a substantially concave shape in respect of the plane A, it is understood that the second section 46 can have any suitable shape as desired such as a substantially convex shape in respect of the plane A, for example.

In yet another non-limiting example illustrated in FIG. 4, the first section 44 of the inner surface 43 has a variable slope in respect of the plane A. The second section 46 of the inner surface 43 has a variable slope in respect of the plane A. As shown, the variable slope of the first section 44 is greater than the variable slope of the second section 46. It is understood that the slope of the first section 44 and the slope of the second section 46 can vary as desired. Although each of the sections 44, 46 has a substantially concave shape in respect of the plane A, it is understood that each of the sections 44, 46 can have any suitable shape as desired such as a substantially convex shape in respect of the plane A, for example.

The configuration of the fluid flow distribution device 12 can also be characterized as having a distance between the inner surface 43 of the upper wall 34 and the plane A which non-uniformly progressively decreases in respect of a general direction of the fluid flow into the fluid flow distribution device 12. Accordingly, a rate of change in a distance D₁ between the first section 44 of the inner surface 43 and the plane A is greater than a rate of change in a distance D₂ between the second section 46 of the inner surface 43 and the plane A. It is understood that the rate of change in the distance D₁ can be substantially constant, as shown in FIGS. 1 and 3, or variable, as shown in FIGS. 2 and 4. It is further understood that the rate of change in the distance D₂ can be substantially constant, as shown in FIGS. 1 and 2, or variable, as shown in FIGS. 3 and 4.

The configuration of the fluid flow distribution device 12 can also be characterized as having a rate of change in volume of a first portion of the chamber 30 adjacent the first section 44 of the inner surface 43 is greater than a rate of change in volume of a second portion of the chamber 30 adjacent the second section 46 of the inner surface 43. It is understood that the rate of change in the volume of the first portion of the chamber 30 adjacent the first section 44 of the inner surface 43 can be substantially constant, as shown in FIGS. 1 and 3, or variable, as shown in FIGS. 2 and 4. It is further understood that the rate of change in the volume of the second portion of the chamber 30 adjacent the second section 46 of the inner surface 43 can be substantially constant, as shown in FIGS. 1 and 2, or variable, as shown in FIGS. 3 and 4.

The configuration of the fluid flow distribution device 12 can also be characterized as having a rate of change in the distance between the inner surface 43 of the upper wall 34 and the plane A which decreases as a distance from the fluid inlet 20 increases. Accordingly, the rate of change in the distance D₁ between the first section 44 of the inner surface 43 and the plane A is greater than the rate of change in the distance D₂ between the second section 46 of the inner surface 43 and the plane A. It is understood that the rate of change in the distance D₁ can be substantially constant, as shown in FIGS. 1 and 3, or variable, as shown in FIGS. 2 and 4. It is further understood that the rate of change in the distance D₂ can be substantially constant, as shown in FIGS. 1 and 2, or variable, as shown in FIGS. 3 and 4.

In operation, the fluid flow from the fluid source enters the fluid flow distribution device 12 through the fluid inlet 20 of the heat exchanger 14. A portion of the fluid flow entering the fluid flow distribution device 12 adjacent the fluid inlet 20 is directed downwardly by the sloped first section 44 of the inner surface 43 into the flow paths 16 adjacent thereto. The remainder of the fluid flow continues to progress through the fluid flow distribution device 12 and is directed downwardly by the sloped second section 46 of the inner. surface 43 into the flow paths 16 adjacent thereto. As a result, the fluid flow decreases in mass across the flow paths 16. Because the distances D₁, D₂ between the respective sections 44, 46 and the plane A non-uniformly progressively decrease in respect of the general direction of the fluid flow into the fluid flow distribution device 12, a substantially constant velocity and a substantially constant static pressure of the fluid flow is maintained as the mass of the fluid flow decreases. As such, the distribution of the fluid flow among the flow paths 16 is substantially uniform, maximizing a performance and an efficiency of the heat exchanger 14.

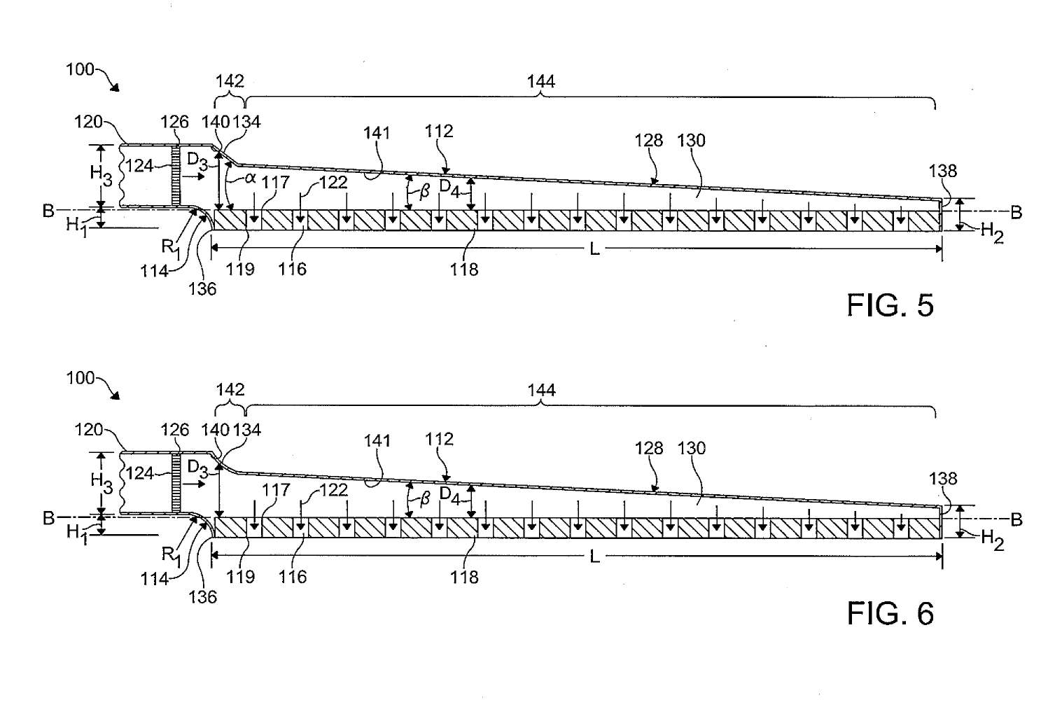

FIGS. 5-10 show a fluid flow component 100 including a fluid flow distribution device 112 according to another embodiment of the invention. The fluid flow distribution device 112 shown is used in connection with an air duct 114 for a zonal air flow system. The air duct 114 includes multiple parallel spaced apart flow paths 116. Each of the flow paths 116 includes an inlet 117 and an outlet 119. The flow paths 116 shown are formed in a planar plate 118. The plate 118 can be, separately or integrally, formed with the air duct 114 as desired. The plate 118 shown has a thickness of about 12.5 mm, a width of about 270 mm, and a length L of about 450 mm. It is understood that the plate 118 can have any suitable dimensions as desired. It is further understood that while the fluid flow distribution device 112 shown is employed in connection with the air duct 114 including the flow paths 116, the fluid flow distribution device 112 can be employed in connection with any other suitable form of air flow system as desired. It is further understood that while the air duct 114 shown includes fifteen (15) flow paths 116, the fluid flow distribution device 112 can be used in any suitable air manifold having two or more flow paths that require the fluid flow to be distributed therebetween. Accordingly, no limitation is intended to a particular type or number of flow paths.

The fluid flow distribution device 112 further includes a fluid inlet 120. The fluid inlet 120 receives a fluid flow, indicated by arrows 122, from a fluid source (not shown). A substantially planar plate 124 may be disposed in the fluid inlet 120 to increase flow resistance within the fluid inlet 120 if desired. In a non-limiting example, the plate 124 includes a plurality of flow paths 126 formed therein. As shown in FIGS. 5-10, the flow paths 126 are evenly spaced apart and have substantially the same diameter. It is understood that the flow paths 126 can be formed in the plate 124 in any suitable pattern and have any suitable diameter, as desired. In a non-limiting example, the plate 124 is generally rectangular and has a thickness of about 0.5 mm, a height H₃ of about 42 mm, and a width of about 270 mm. It is understood, however, that the plate 124 can have any shape and size as desired.

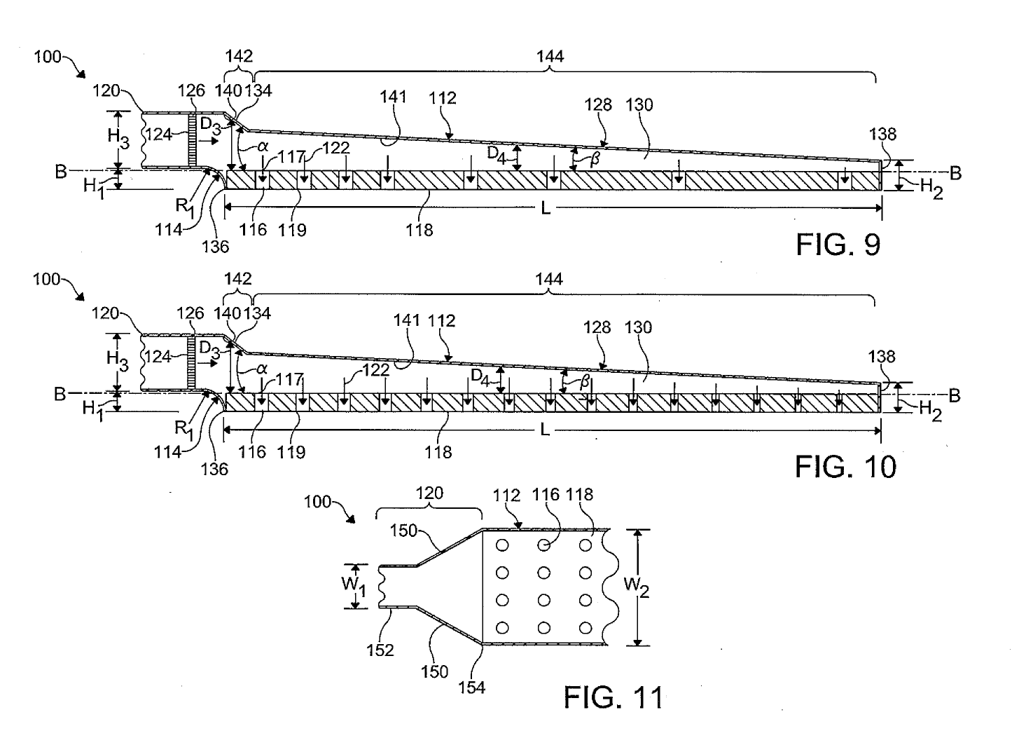

The fluid flow is distributed among the flow paths 116 for a distribution of air to a passenger compartment (not shown) of a vehicle (not shown). In certain embodiments, the flow paths 116 are evenly spaced apart and have substantially the same diameter, as shown in FIGS. 5-8. In other embodiments, a flow resistance is gradually increased within the fluid flow distribution device 112 across the plate 118 from a side of the plate 118 adjacent the fluid inlet 120 to a side of the plate 118 opposite the fluid inlet 120 by increasing a space between the flow paths 116, as shown in FIG. 9, and/or decreasing a diameter of the flow paths 116, as shown in FIG. 10. It is understood that the flow paths 116 can be formed in the plate 118 in any suitable pattern and have any suitable diameter as desired.

As shown in FIGS. 5-10, the fluid flow distribution device 112 includes an outer peripheral wall 128 forming a chamber 130 for receiving the fluid flow therein. In certain embodiments, the outer wall 128 of the fluid flow distribution device 112 is formed by an upper wall 134, a front wall (not shown), a rear wall (not shown), a first side wall 136, and a second side wall 138. In a non-limiting example, the upper wall 134 has a length L of about 450 mm, the first side wall 136 has a height H₁ of about 13 mm, the second side wall 138 has a height H₂ of about 22.5 mm, and a distance between the upper wall 134 and a surface of the plate 118 adjacent the second side wall 138 is about 8 mm. As shown, the first side wall 126 includes a radius R₁ formed therein. The radius R₁ causes the fluid flow to curl when entering the chamber 130 and be directed downwardly into the flow paths 116 adjacent thereto. In a non-limiting example, the radius R₁ of the first side wall 126 is about 0.5 mm. An inlet orifice 140 in fluid communication with the fluid inlet 120 of the air duct 114 is formed in the fluid flow distribution device 112. In a non-limiting example, the fluid inlet 120 has a height H₃ of about 42 mm. It is understood that the walls 134, 136, 138 and the fluid inlet 120 can have any dimensions as desired.

The upper wall 134 of the fluid flow distribution device 112 has an inner surface 141. In certain embodiments, the upper wall 134 of the fluid flow distribution device 112 includes a first section 142 and a second section 144. As shown, the first section 142 is adjacent the fluid inlet 120 and extends between the inlet orifice 140 and the second section 144. The second section 144 is adjacent the first section 142 and extends between the first section 142 and the second side wall 138. In a non-limiting example illustrated in FIG. 5, the first section 142 of the upper wall 134 has a substantially constant slope at an angle α in respect of a plane B generally defined by the inlets 117 of the flow paths 116. In certain embodiments, the angle α is about 39 degrees in respect of the plane B. Further, the second section 144 of the upper wall 134 has a substantially constant slope at an angle β in respect of the plane B. In certain embodiments, the angle β is about 3 degrees in respect of the plane B. As shown, the angle of slope a of the first section 142 is greater than the angle of slope 3 of the second section 144. It is understood that the substantially constant slope of the first section 142 and the substantially constant slope of the second section 144 can be at any suitable angles as desired.

In another non-limiting example illustrated in FIG. 6, the first section 142 of the upper wall 134 has a variable slope in respect of the plane B. The second section 144 of the upper wall 134 has a substantially constant slope at an angle β in respect of the plane B. In certain embodiments, the angle β is about 3 degrees in respect of the plane B. As shown, the variable slope of the first section 142 is greater than the angle of slope β of the second section 144. It is understood that the slope of the first section 142 can vary as desired and the substantially constant slope of the second section 144 can be at any suitable angle as desired. Although the first section 142 shown has a substantially concave shape in respect of the plane B, it is understood that the first section 142 can have any suitable shape as desired such as a substantially convex shape, for example.

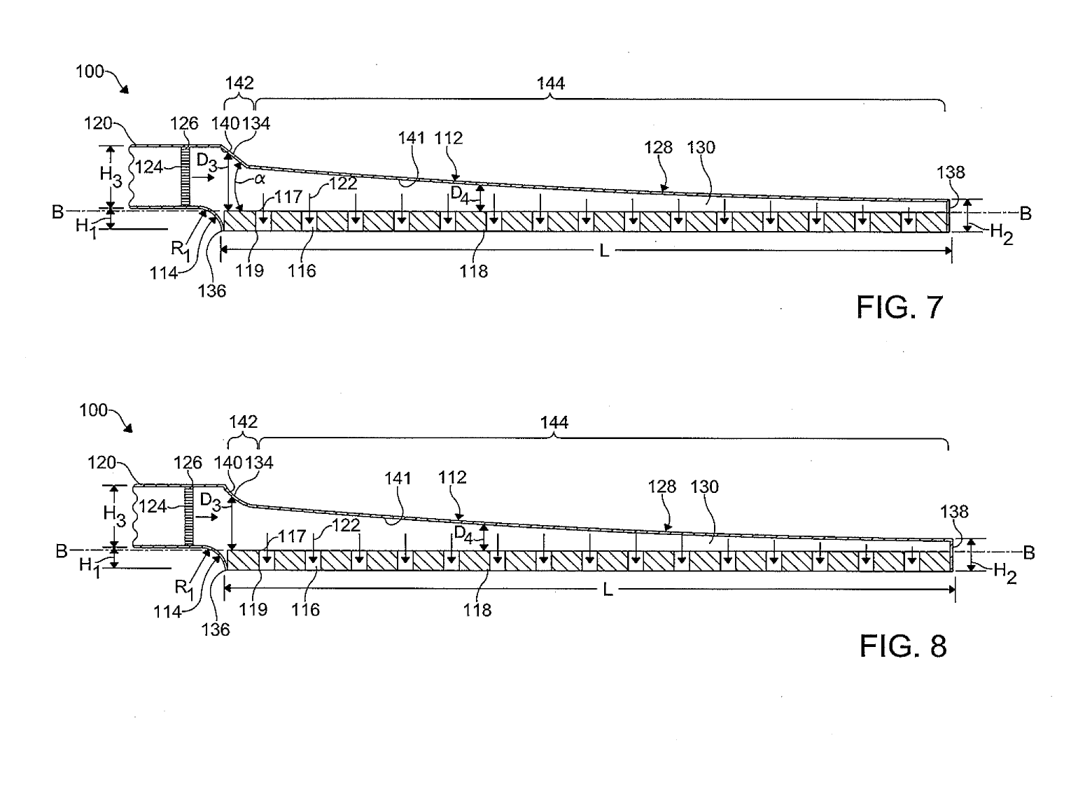

In yet another non-limiting example illustrated in FIG. 7, the first section 142 of the upper wall 134 has a substantially constant slope at an angle α in respect of the plane B. In certain embodiments, the angle α is about 39 degrees in respect of the plane B. Further, the second section 144 of the upper wall 134 has a variable slope in respect of the plane B. As shown, the angle of slope α of the first section 142 is greater than the variable slope of the second section 144. It is understood that the substantially constant slope of the first section 142 can be at any suitable angle as desired and the slope of the second section 144 can vary as desired. Although the second section 144 shown has a substantially concave shape in respect of the plane B, it is understood that the second section 144 can have any suitable shape as desired such as a substantially convex shape, for example.

In yet another non-limiting example illustrated in FIG. 8, the first section 142 of the upper wall 134 has a variable slope in respect of the plane B. The second section 144 of the upper wall 134 has a variable slope in respect of the plane B. As shown, the variable slope of the first section 142 is greater than the variable slope of the second section 144. It is understood that the slope of the first section 142 and the slope of the second section 144 can vary as desired. Although each of the sections 142, 144 shown has a substantially concave shape in respect of the plane B, it is understood that each of the sections 142, 144 can have any suitable shape as desired such as a substantially convex shape, for example.

The configuration of the fluid flow distribution device 112 can also be characterized as having a distance between the inner surface 141 of the upper wall 134 and the plane B which non-uniformly progressively decreases in respect of a general direction of the fluid flow into the fluid flow distribution device 112. Accordingly, a rate of change in a distance D₃ between the first section 142 of the inner surface 141 and the plane B is greater than a rate of change in a distance D₄ between the second section 144 of the inner surface 141 and the plane B. It is understood that the rate of change in the distance D₃ can be substantially constant, as shown in FIGS. 5 and 7, or variable, as shown in FIGS. 6 and 8. It is further understood that the rate of change in the distance D₄ can be substantially constant, as shown in FIGS. 5 and 6, or variable, as shown in FIGS. 7 and 8.

The configuration of the fluid flow distribution device 112 can also be characterized as having a rate of change in volume of a first portion of the chamber 130 adjacent the first section 142 of the inner surface 141 is greater than a rate of change in volume of a second portion of the chamber 130 adjacent the second section 144 of the inner surface 141. It is understood that the rate of change in the volume of the first portion of the chamber 130 adjacent the first section 142 of the inner surface 141 can be substantially constant, as shown in FIGS. 5 and 7, or variable, as shown in FIGS. 6 and 8. It is further understood that the rate of change in the volume of the second portion of the chamber 130 adjacent the second section 144 of the inner surface 141 can be substantially constant, as shown in FIGS. 5 and 6, or variable, as shown in FIGS. 7 and 8.

The configuration of the fluid flow distribution device 112 can also be characterized as having a rate of change in the distance between the inner surface 141 of the upper wall 134 and the plane B which decreases as a distance from the fluid inlet 120 increases. Accordingly, the rate of change in the distance D₃ between the first section 142 of the inner surface 141 and the plane B is greater than the rate of change in the distance D₄ between the second section 144 of the inner surface 141 and the plane B. It is understood that the rate of change in the distance D₃ can be substantially constant, as shown in FIGS. 5 and 7, or variable, as shown in FIGS. 6 and 8. It is further understood that the rate of change in the distance D₄ can be substantially constant, as shown in FIGS. 5 and 6, or variable, as shown in FIGS. 7 and 8.

As shown in FIG. 11, the fluid inlet 120 can include a pair of outwardly tapered side walls 150. As such, the fluid inlet 120 performs as a diffuser to decrease a speed and increase a pressure of the fluid flow entering the fluid flow distribution device 112. In a non-limiting example, an inlet end 152 of the fluid inlet 120 has a width W1 of about 100 mm and an outlet end 154 of the fluid inlet 120 has a width W2 of about 270 mm. It is understood, however, that the fluid inlet 120 can have any shape and size as desired.

In operation, the fluid flow from the fluid source enters the fluid flow distribution device 112 through the fluid inlet 120 of the air duct 114. A portion of the fluid flow entering the fluid flow distribution device 112 adjacent the fluid inlet 120 is directed downwardly by the radius R₁ of the first side wall 136 and the sloped first portion 142 into the flow paths 116 adjacent thereto. The remainder of the fluid flow continues to progress through the fluid flow distribution device 112 and is directed downwardly by the sloped second portion 144 into the flow paths 116 adjacent thereto. As a result, the fluid flow decreases in mass across the flow paths 116. Because the distances D₃, D₄ between the respective sections 142, 144 and the plane B non-uniformly progressively decrease in respect of the general direction of the fluid flow into the fluid flow distribution device 112, a substantially constant velocity and a substantially constant static pressure of the fluid flow is maintained as the mass of the fluid flow decreases. As such, the distribution of the fluid flow among the flow paths 116 is substantially uniform, maximizing a performance and an efficiency of the air duct 114.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A fluid flow distribution device, comprising:
a plurality of walls forming a chamber configured to receive a fluid flow therein, wherein the chamber is in fluid communication with a fluid inlet and a plurality of flow paths, each of the flow paths having an inlet, wherein a distance between an inner surface of at least one of the walls and a plane generally defined by the inlets of the flow paths non-uniformly progressively decreases in respect of a general direction of the fluid flow into the fluid flow distribution device.

2. The device according to claim 1, wherein the flow paths are defined by a plurality of tubes.

3. The device according to claim 1, wherein the flow paths are formed in a substantially planar plate.

4. The device according to claim 3, wherein at least one of a spacing between the flow paths and a diameter of each of the flow paths varies across the substantially planar plate.

5. The device according to claim 1, wherein one of the walls includes a radius formed therein to direct the fluid flow into the flow paths.

6. The device according to claim 1, wherein the inner surface includes a first section adjacent the fluid inlet and a second section adjacent the first section, and wherein a rate of change in the distance between the first section of the inner surface of the at least one of the walls and the plane generally defined by the inlets of the flow paths is greater than a rate of change in the distance between the second section of the inner surface of the at least one of the walls and the plane generally defined by the inlets of the flow paths.

7. The device according to claim 6, wherein the rate of change in the distance between the first section of the inner surface of the at least one of the walls and the plane generally defined by the inlets of the flow paths is substantially constant.

8. The device according to claim 6, wherein the rate of change in the distance between the first section of the inner surface of the at least one of the walls and the plane generally defined by the inlets of the flow paths is variable.

9. The device according to claim 6, wherein the rate of change in the distance between the second section of the inner surface of the at least one of the walls and the plane generally defined by the inlets of the flow paths is substantially constant.

10. The device according to claim 6, wherein the rate of change in the distance between the second section of the inner surface of the at least one of the walls and the plane generally defined by the inlets of the flow paths is variable.

11. The device according to claim 1, wherein the fluid inlet is configured to perform as a diffuser to decrease a speed and increase a pressure of the fluid flow entering the chamber.

12. The device according to claim 1, wherein the fluid inlet includes a substantially planar second plate having a plurality of spaced apart flow paths formed therein.

13. The device according to claim 12, wherein a flow resistance within the fluid inlet is increased by at least one of increasing a spacing between the flow paths of the substantially planar second plate and decreasing a diameter of each of the flow paths of the substantially planar second plate.

14. A fluid flow distribution device, comprising:
a plurality of walls forming a chamber configured to receive a fluid flow therein, the chamber in fluid communication with a fluid inlet and a plurality of flow paths, wherein at least one of the walls includes an inner surface having a first section adjacent the fluid inlet and a second section adjacent the first section, and wherein a rate of change in volume of a first portion of the chamber adjacent the first section of the inner surface is greater than a rate of change in volume of a second portion of the chamber adjacent the second section of the inner surface.

15. The device according to claim 14, wherein the rate of change in the volume of the first portion of the chamber is one of substantially constant and variable.

16. The device according to claim 14, wherein the rate of change in the volume of the second portion of the chamber is one of substantially constant and variable.

17. A fluid flow distribution device, comprising:
a plurality of walls forming a chamber configured to receive a fluid flow therein, wherein the chamber is in fluid communication with a fluid inlet and a plurality of flow paths, each of the flow paths including an inlet, wherein a rate of change in distance between an inner surface of at least one of the walls and a plane generally defined by the inlets of the flow paths decreases as a distance from the fluid inlet increases.

18. The device according to claim 17, wherein the at least one wall includes an inner surface having a first section adjacent the fluid inlet and a second section adjacent the first section, and wherein a rate of change in the distance between the first section of the inner surface of the at least one of the walls and the plane generally defined by the inlets of the flow paths is greater than a rate of change in the distance between the second section of the inner surface of the at least one of the walls and the plane generally defined by the inlets of the flow paths.

19. The device according to claim 18, wherein the rate of change in the distance between the first section of the inner surface of the at least one of the walls and the plane generally defined by the inlets of the flow paths is one of substantially constant and variable.

20. The device according to claim 18, wherein the rate of change in the distance between the first section of the inner surface of the at least one of the walls and the plane generally defined by the inlets of the flow paths is one of substantially constant and variable.
